(19) United States
(12) Patent Application Publication
(10) Pub. No.: US 2026/0143568 A1
(43) Pub. Date: May 21, 2026

(54) TUBE HEATING ELEMENT WITH FRIT-COATED CARBON FIBER YARN

(71) Applicant: Trebor International, Inc., West Jordan, UT (US)

(72) Inventors: Aaron Olson, South Jordan, UT (US); Scott Brown, Riverton, UT (US)

(73) Assignee: Trebor International, Inc., West Jordan, UT (US)

(21) Appl. No.: 19/382,400

(22) Filed: Nov. 7, 2025

Related U.S. Application Data
(60) Provisional application No. 63/721,079, filed on Nov. 15, 2024.

(51) Int. Cl. H05B 3/46; H05B 3/12

(52) U.S. Cl. CPC H05B 3/46; H05B 3/12; H05B 2203/016; H05B 2203/017

(57) ABSTRACT

A heating element is provided and includes a ceramic tube. The ceramic tube has a central portion arranged between a first end portion and a second end portion. Carbon fiber yarn is wrapped around the ceramic tube from the first end portion to the second end portion. A frit coating is at least arranged on the carbon fiber yarn that is wrapped around the central portion of the ceramic tube. A first conductive component is coupled to the carbon fiber yarn at the first end portion of the ceramic tube, and a second conductive component is coupled to the carbon fiber yarn at the second end portion of the ceramic tube.

### RELATED APPLICATIONS

This application claims priority to U.S. Provisional Patent Application No. 63/721,079 filed on Nov. 15, 2024.

### FIELD OF INVENTION

The present invention relates generally to a tube heating element comprising a ceramic tube covered in a frit-coated carbon fiber yarn to improve heating efficiency.

### BACKGROUND

Tube heaters are used in deionized water and chemical applications that require purity process control, high temperatures, and small footprints. The water and/or chemicals travel through the tube while the tube provides heat to the water and/or chemicals. Contamination risk through reactions with the heater material is reduced when the heater comprises a ceramic.

### SUMMARY OF INVENTION

According to one aspect, a heating element is provided. The heating element includes a ceramic tube and carbon fiber yarn wrapped around a central portion of the ceramic tube. The carbon fiber yarn is coated in a frit composition. At end portions of the ceramic tube which surround the central portion, the carbon fiber yarn may be substantially free from the frit composition. Electrodes are coupled to the carbon fiber yarn substantially free from the frit composition at each end portion of the ceramic tube.

According to another aspect, a method of forming a heating element is provided. The method includes obtaining a ceramic tube comprising a central portion between end portions. A texturizing process may be performed to change the texture of the central portion. A first layer of conductive paint is applied to the end portions of the ceramic tube. Carbon fiber yarn is coated in a frit composition and wound onto the ceramic tube. The frit composition may be removed from the carbon fiber yarn wound around the conductive paint at the end portions of the ceramic tube. A second layer of conductive paint is applied over the carbon fiber yarn at the end portions. The ceramic tube may then be heated to cure the frit composition.

The foregoing and other features of the application are described below with reference to the drawings.

### BRIEF DESCRIPTION OF THE DRAWINGS

FIG. 1 illustrates a side view of some embodiments of a tube heating element covered by a frit-coated fiber yarn.

FIGS. 2 and 3 illustrate cross-sectional views, taken about cross section line AA′ of FIG. 1, of various embodiments of an end portion of a tube heating element comprising electrical connection components.

FIG. 4 illustrates a side view of some embodiments of a ceramic tube of a tube heating element.

FIGS. 5 and 6 illustrate cross-sectional views of various embodiments of carbon fiber yarn coated with a frit composition.

FIGS. 7, 8, 9, and 10 illustrate side views of various embodiments of winding patterns for a frit-coated carbon fiber yarn over a ceramic tube.

### DETAILED DESCRIPTION

The principles of the present application relate to a heating element, such as a ceramic tube heater, and thus will be described below in this context. It will be appreciated that the principles of the application may be applicable to processing applications that rely on the delivery of pure solutions (e.g., chemicals, ultrapure water, deionized water, and even gas) at particular temperatures such as in the formulation space or semiconductor manufacturing processing space for etching processes, deposition processes, cleaning processes, and the like.

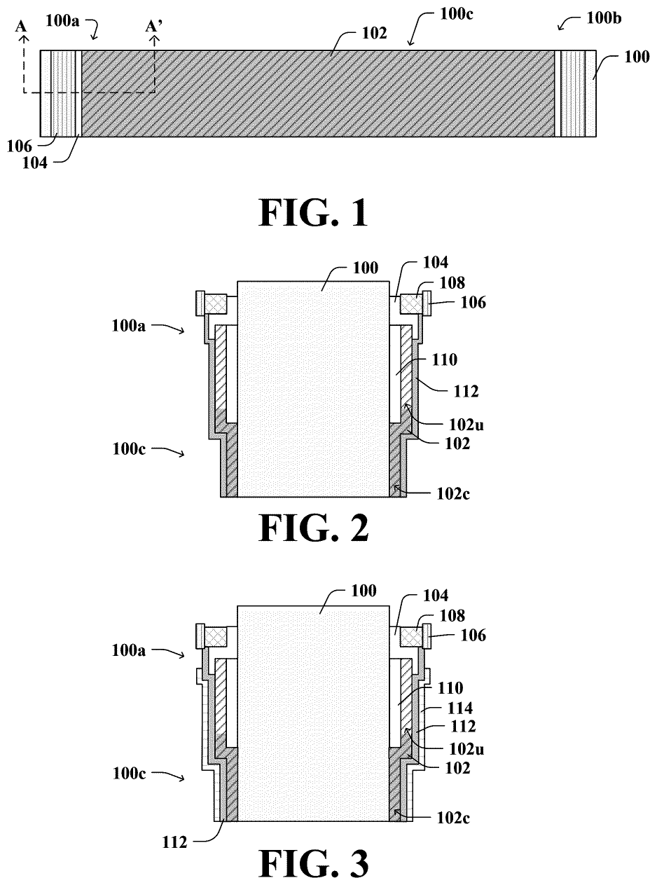

Turning now to FIG. 1, a heating element is shown generally. The heating element includes a ceramic tube 100 that is covered by various layers and elements. The ceramic tube 100 may comprise quartz or some other nonreactive material with little absorption properties such that uncontaminated water or chemicals can enter the tube and exit the tube while remaining uncontaminated. The ceramic tube 100 has a first end portion 100a, a second end portion 100b opposite to the first end portion 100a, and a central portion 100c arranged between the first and second end portions 100a, 100b. Each of the first and second end portions 100a, 100b is coupled to an inlet or outlet (not shown) to direct a fluid through the ceramic tube 100 for heating.

The central portion 100c of the ceramic tube is covered in a frit-coated carbon fiber yarn 102. The frit-coated carbon fiber yarn 102 is wrapped around the outside of the ceramic tube 100. Several strands of the frit-coated carbon fiber yarn 102 may be wrapped around in various configurations on the ceramic tube 100 as will be discussed further herein. The frit-coated carbon fiber yarn 102 comprises carbon fiber yarn that has been submerged in a frit composition bath. In some embodiments, several passes in the frit composition bath are conducted to ensure the frit composition layer covers the carbon fiber yarn. After the bath coating process, the carbon fiber yarn is substantially covered by the frit composition layer. Carbon fiber provides a favorable electric-heat conversion efficiency of more than 95%. It will be appreciated that the disclosed carbon fiber “yarn” may be a continuous piece of carbon fiber, a compilation of several small fibers or filaments, a braided configuration of several strands of carbon fiber yarn, a twisted configuration of several strands of carbon fiber yarn, or the like. In some embodiments, the carbon fiber yarn may contain a coating on it to adhere the carbon filaments together. The coating may comprise, for example, an epoxy-monomer that can withstand the high operating temperatures of the heating element.

When power is applied to the carbon fiber yarn 102, the carbon fiber yarn 102 produces heat which is transferred to the ceramic tube 100. The heated ceramic tube 100 surrounds a fluid (e.g., water, chemicals, gases) passing therethrough. The passing fluid can directly contact the inside surfaces of the ceramic tube 100. Thus, the passing fluid can be heated within the ceramic tube 100 via convection and conduction. The frit composition is a ceramic and more particularly, is a mixture of silica and fluxes that are fused at a high temperature to form a glass. The frit composition includes a thinner and the ceramic powders. In some embodiments, the frit composition includes silicon, phosphate, quartz, metal oxides (e.g., zirconium oxide, magnesium oxide, aluminum oxide), some other suitable material, or a combination thereof. Upon curing, the frit composition forms a stable ceramic around the carbon fiber.

At the central portion 100c, the frit composition on the frit-coated carbon fiber yarn 102 directly contacts the ceramic tube 100 to bond the carbon fiber yarn to the ceramic tube 100. The frit composition of the frit-coated carbon fiber yarn 102 also provides insulation of the carbon fiber to prevent oxidation of the carbon fiber and acts as an electrical insulator for the carbon fiber. The frit composition acts as a thermal conductor and thus, transfers heat from the carbon fiber yarn 102 to the ceramic tube 100. The central portion 100c of the ceramic tube 100 is configured to provide heat but not electricity to the ceramic tube 100 and the fluid passing therethrough.

The first and second end portions 100a, 100b of the ceramic tube 100 comprise various electrically conductive components to provide power to the carbon fiber yarn 102 such that the carbon fiber yarn 102 can produce heat in the central portion 100c. In some embodiments, the electrically conductive components include a top conductive layer 104 and a conductive clamp 106. The electrically conductive components may be the same at the first end portion 100a and the second end portions 100b of the ceramic tube 100.

Turning additionally to FIG. 2, a cross-sectional view of the ceramic tube 100 including the first end portion 100a and part of the adjacent central portion 100c is shown. The cross-sectional view of the ceramic tube 100 in FIG. 2 may correspond to cross-section line AA′ of FIG. 1 and may include additional components than what is shown in FIG. 1.

The electrically conductive components at the first end portion 100a can further include a braided wire band 108 arranged below the conductive clamp 106 and a bottom conductive layer 110 arranged directly on the ceramic tube 100. An insulating layer (not shown) may be arranged over the conductive clamp 106 and braided wire band 108. For example, shrink wrap may be used to insulate the conductive clamp 106 and braided wire band 108. The insulating layer, such as shrink wrap, may also be arranged over other heating elements for insulation. In some embodiments, before the frit-coated carbon fiber yarn 102 is wrapped around the ceramic tube 100, a bottom conductive layer 110 is formed on the first end portion 100a of the ceramic tube 100. The bottom conductive layer 110 may be an electrically conductive sheet, wire, paint, or the like. For example, the bottom conductive layer 110 comprises a silver paint such that when dry, the conductive layer 110 is bonded to the ceramic tube 100. The carbon fiber yarn 102 comprises a covered portion 102c, comprising the frit composition on the outside of the carbon fiber yarn 102, and an uncovered portion 102u, which is the carbon fiber yarn 102 substantially free of the frit composition. “Substantially free” means that up to about 35% or more preferably up to about 10% of the carbon fiber yarn 102 in the uncovered portion 102u at the end portions 100a, 100b of the ceramic tube 100 is still covered with some residual frit composition.

Because the frit composition is an electrical insulator, the frit composition may be removed from the carbon fiber yarn 102 at the first end portion 100a to expose and electrically couple the carbon fiber yarn 102 to the various electrically conductive components. Thus, in some embodiments, at least some of the carbon fiber yarn 102 in contact with the bottom conductive layer 110 is uncovered at portion 102u and substantially free of the frit composition. In some other embodiments, the uncovered portion 102u may be omitted such that the carbon fiber yarn 102 extending between the first and second end portions 100a, 100b is covered with substantially same amount of frit composition. In some such other embodiments, the amount of frit covering the carbon fiber yarn 102 still allows for sufficient electrical conductivity between the carbon fiber yarn 102 and conductive components in contact with the carbon fiber yarn 102 configured to deliver power to the carbon fiber yarn 102.

The top conductive layer 104 is arranged over at least part of the carbon fiber yarn 102 at the first end portion 110a of the tube 100. In some embodiments, the top conductive layer 104 contacts outer surfaces and the tips of the carbon fiber yarn 102 at the respective end portions 100a, 100b. For example, in FIG. 2, where the carbon fiber yarn 102 is uncovered 102u at the end portions 100a, 100b, the top conductive layer 104 contacts outer surfaces and the tips of the uncovered portion 102u of the carbon fiber yarn. The bottom conductive layer 110 contacts at least inner surfaces of the uncovered portion 102u of the carbon fiber yarn. It will be appreciated the bottom conductive layer 110 may also contact the tips and/or outer surfaces of the carbon fiber yarn 102, and the top conductive layer 104 may also contact the inner surfaces of the carbon fiber yarn 102. The top conductive layer 104 may comprise a same or similar material as the bottom conductive layer 110.

A braided wire band 108 may surround the top conductive layer 104 and/or the uncovered portion 102u of the carbon fiber yarn 102. In some embodiments, the braided wire band 108 comprises silver, silver-plated copper, copper-plated silver, or some other suitable electrically conductive material. The braided wire band 108 and the top and bottom conductive layers 104, 110 may include silver and/or copper as these materials have a lower electrical resistance than that of, for example, aluminum and steel. The power supply may be applied directly to the braided wire band 108, the clamp 106, and/or the top and bottom conductive layers 104, 110.

The conductive clamp 106 may apply pressure to the underlying electrically conductive components (102u, 104, 108, and/or 110) to ensure there is physical and thus, electrical contact between the components. The conductive clamp 106 comprises a strong material that is also electrically conductive such as aluminum, steel, or some other suitable material. In some embodiments, a solder material is applied to the electrical components to ensure their mechanical integrity and electrical connections. The electrical components form an electrode such as the braided wire band 108 and/or conductive clamp 106 to provide power to the carbon fiber yarn 102 through the uncovered portion 102u with little resistance.

In some embodiments, a protective frit layer 112 is applied to the carbon fiber yarn 102 to cover the carbon fiber yarn 102 between the clamp 106 at the first end portion 100a of the ceramic tube 100 to the second end portion 100b of the ceramic tube 100. The protective frit layer 112 helps secure the carbon fiber yarn 102, electrically isolate the carbon fiber yarn 102 to reduce arcing, and protect the carbon fiber yarn 102 from oxidation. For example, when unprotected, carbon fibers begin to react with oxygen and shrink at temperatures greater than about 350 degrees Celsius. Thus, the oxidation resistance provided by the protective frit layer 112 ensures the carbon fiber yarn 102 remains intact even at high heating temperatures. The protective frit layer 112 may comprise a different composition than the frit on the carbon fiber yarn 102.

FIG. 3 illustrates a similar design as FIG. 2 but with an insulating shield 114. The insulating shield 114 surrounds the carbon fiber yarn 102 to provide thermal insulation and mechanical protection for the carbon fiber yarn 102 and ceramic tube 100. The insulating shield 114 may cover at least the central portion 100c and extend between the first end portion 100a and the second end portion 110b of the ceramic tube 100. The insulating shield 114 may be electrically conductive and thus, does not contact the conductive clamp 106, braided wire band 108 and/or conductive layers 104, 110. Thus, as shown in FIG. 3, the insulating shield 114 is spaced apart from the conductive clamp 106 and the braided wire band 108. In some embodiments the protective frit layer 112 or some other electrically insulating material may be arranged directly between the insulating shield 114 and the other conductive features at the end portions 100a, 100b. The insulating shield 114 helps direct the thermal energy towards the ceramic tube 100 to improve heating efficiency. Because the cured frit composition on the carbon fiber yarn 102 can be delicate, the insulating shield 114 also protects damage to the frit composition. In some embodiments, the insulating shield 114 comprises aluminum, stainless steel, a ceramic paper, or some other suitable material. In some embodiments, a tape (e.g., Kapton tape), a clamp, or some other suitable securing mechanism is used to keep the insulating shield 114 in place.

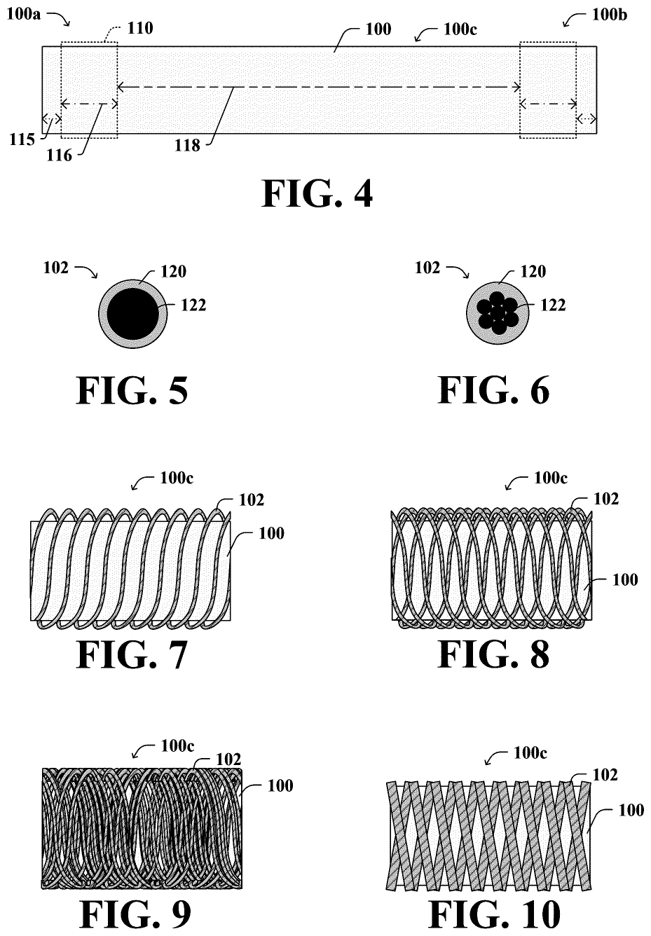

Turning additionally to FIG. 4, the ceramic tube 100 without any layers formed or arranged thereon is illustrated. A dotted box is illustrated at the end portions 100a, 100b to designate where the bottom conductive layer 110 may be arranged after the processing of the ceramic tube 100. Different portions of the ceramic tube 100 may be pretreated according to different protocols. For example, in some embodiments, the central portion 100c of the ceramic tube 100 is prepared to have a higher surface roughness compared to the first and second end portions 100a, 100b. The central portion 100c may be treated to have a rougher surface through bead blasting or some other suitable technique. This way, the bonding strength between the frit composition and the ceramic tube 100 at the central portion 100c is increased. Rougher end portions 100a, 100b may also promote adhesion between the bottom conductive layer 110 and the ceramic tube 100. In some other embodiments, the surface roughness at the central 100c and end portions 100a, 100b is substantially similar. To protect the integrity of the ceramic tube 100, the outermost ends 115 may remain untreated. Thus, prior to application of any material or component, a central length 118 of the ceramic tube 100 is bead blasted to provide a first roughness, end portion lengths 116 are bead blasted to provide a second roughness, and the outermost ends 115 are protected from any bead blasting. In other embodiments, pretreatment of the ceramic tube 100 is omitted without compromising adhesion between the frit-coated carbon fiber yarn and the ceramic tube 100.

A method of forming the heating element described herein is now disclosed. It will be appreciated that the method is not limited to the order and particular processing techniques discussed below. Further, one or more steps may be omitted, depending on the final design of the heating element.

The ceramic tube 100 may be placed on a mandrel of a carbon fiber winding machine. If pretreatment is performed, then the pretreatment steps would be performed before layers are applied to the ceramic tube 100. The bottom conductive layer 110 is applied to the ceramic tube 100 to provide a first part of an electrode (i.e., electrically conductive components) for the heating element. In some embodiments, the bottom conductive layer 110 is painted on the ceramic tube 100 at the end portions 100a, 100b at a nonzero distance from the outermost ends of the ceramic tube 100. For example, the bottom conductive layer 110 may be arranged about 1 to 5 inches from the outermost ends of the ceramic tube 100 such that outermost ends of the ceramic tube 100 that do not have the bottom conductive layer 110 arranged thereon can be handled without risk of electrical contact.

A frit composition mixture may then be mixed in a bath section of the carbon fiber winding machine. In some embodiments, the frit composition comprises a thinner and a frit powder in a 1:1 ratio. In some other embodiments, the thinner to frit powder ratio ranges from about 0:1 to about 4:1. A carbon fiber yarn is then run through the bath of the frit composition and tied to an end of a mandrel in preparation for winding. The frit-coated carbon fiber yarn 102 is then wound onto the ceramic tube 100 according to a desired winding pattern (e.g., space between adjacent strands, number of layers/overlapping of layers, etc.) to target specific resistances, as will be discussed further herein with respect to FIGS. 7-10.

After the coated carbon fiber yarn 102 is wound onto the ceramic tube 100 according to the desired pattern, the yarn 102 is tied off of the mandrel. In embodiments where end portions of the carbon fiber yarn 102 are substantially free of the frit composition, outermost ends of the carbon fiber yarn 102 at the end portions 100a, 100b of the ceramic tube 100 are then dipped in water (or some other suitable solution) to remove the frit composition from the yarn 102 and form the uncovered portions 102u of the carbon fiber yarn 102 at the end portions 100a, 100b of the ceramic tube 100. In some embodiments, the end portions 100a, 100b are dipped in water at least to remove frit from the carbon fiber yarn 102 arranged on the bottom conductive layer 110. In some such embodiments, the frit composition is water soluble.

After cleaning frit from the end portions 100a, 100b (if performed), a temporary clamping device (not shown) is wrapped around the uncovered portions 102u of the carbon fiber yarn 102 at the first and second end portions 100a, 100b. The carbon fiber at the end portions 100a, 100b is then cut at the outer edges of temporary clamping device. The carbon fiber yarn 102 may rest to dry, and then the ceramic tube 100 can be placed in an oven to cure the frit composition according to a curing heating cycle. After the frit composition has cured, the temporary clamping device is removed. The top conductive layer 104 is then, in some embodiments, applied to the tips and/or outer surfaces of the cut carbon fiber yarn 102 to electrically connect the carbon fiber yarn 102 and the bottom conductive layer 110 to one another. The braided wire band 108 is placed around the top conductive layer 104, and the clamp 106 is used to secure the braided wire band 108 around the ceramic tube 100 overlying the top conductive layer 104. A protective coating, such as additional frit (e.g., 114 of FIG. 2) or a glaze may be applied to any exposed and uncoated carbon fiber yarn 102 at the first and second end portions 100a, 100b to prevent oxidation thereto. The ceramic tube 100 and components formed thereon may then be dried and placed in an oven to cure the additional frit composition (e.g., 114 of FIG. 2) according to another curing heating cycle. Another protective feature such as the insulating shield of FIG. 3 may be secured to the ceramic tube 100.

In some other embodiments, the braided wire band 108 and/or the conductive clamp 106 is omitted. In some such embodiments, after the carbon fiber yarn 102 is cleaned at the end portions 100a, 100b, the carbon fiber yarn 102 is cut and folded back onto itself over the bottom conductive layer 110. The top conductive layer 104 may then be applied over the folded carbon fiber yarn 102 at the end portions 100a, 100b, which may sufficiently secure the carbon fiber yarn 102 to the end portions 100a, 100b without use of a clamp (e.g., 106).

The resulting heating element requires less energy to reach desired heating temperatures because of the carbon fiber properties and the use of a frit composition to provide adhesion and also thermal conductivity. Additionally, the use of frit-coated carbon fiber yarn eliminates the use of some volatile chemicals traditionally used for bonding a thermally conductive component onto a ceramic tube through plating.

The resulting heating element can then be coupled to a power supply to provide heat to the ceramic tube for heating fluids traveling therethrough. In some embodiments, the heating element disclosed herein can use about the same amount of power as conventional techniques while increasing the temperature provided to the fluid by about 10% more than conventional techniques, thereby improving thermal efficiency. In other embodiments, the heating element disclosed herein may require less power to achieve the same heating characteristics provided by conventional techniques. If the ceramic tube provides more heat to fluid traveling therethrough, the flow rate of the fluid may be increased while still achieving a desired temperature, which ultimately increases manufacturing outputs and saves costs. Similarly, with a higher temperature provided to the ceramic tube, the ceramic tube length may be reduced, thereby reducing the footprint of the heating element while still providing a same temperature increase for the fluid as provided in conventional, yet longer heating elements. The availability and cost of carbon fiber has also improved such that this improved thermal efficiency does not come at an added materials cost. In fact, using frit-coated carbon fiber yarn on a ceramic tube may be 40-50% cheaper than conventional techniques such as a nickel-plated ceramic tube.

Turning additionally to FIGS. 5 and 6, example structures of frit-coated carbon fiber yarn 102 are shown. At FIG. 5, the carbon fiber 122 may be a singular strand that is continuously covered by the frit composition 120. The frit composition 120 may be applied as a single layer or several layers of the frit composition 120 around the carbon fiber 122. When the frit composition 120 includes several layers, one or more of the layers may comprise a different frit composition.

At FIG. 6, the frit-coated carbon fiber yarn 102 may contain several strands in a braided or twisted configuration that are together covered with the frit composition 120. It will be appreciated that other carbon fiber formulations/structures (e.g., sourcing, threadcount, resin, size, etc.) and its associated material properties (e.g., tensile strength, etc.) are also in the scope of this disclosure. For example, the carbon fiber may be PITCH-based carbon fiber or PAN-based carbon fiber. PITCH-based carbon fiber has a higher thermal conductivity but is more brittle than PAN-based carbon fiber. Thus, whether PITCH- or PAN-based carbon fiber can depend on the mechanical, thermal, and/or electrical properties needed for a particular application. The carbon fiber yarn 102 can have a tow size (relating to the filament count) ranging from, for example, 3K to 48K. The tow size can influence the electrical properties and mechanical properties of the carbon fiber yarn 102. In some embodiments, the tow size of the carbon fiber yarn 102 is between about 1K and 5K to reduce resistance.

Turning additionally to FIGS. 7-10, exemplary winding patterns are shown. A winding pattern may generally refer to the direction, angle, number of layers, and spacing between the frit-coated carbon fiber yarn 102 wrapped around the central portion 100c of the ceramic tube 100. The parameters of the winding pattern can be tuned to achieve desired heating properties of the heating element. For example, when the spacing between the carbon fiber yarn 102 along the axial direction is increased, the resistance is generally increased. This is because increasing the length of the carbon fiber yarn 102 increases resistance. There is a balance between decreasing the spacing between adjacent carbon fiber windings, increasing the carbon fiber length, and reducing the resistance.

For example, in FIG. 7, the carbon fiber yarn 102 is wound around the ceramic tube 100 once (once from left to right). The carbon fiber yarn 102 does not overlap directly on itself, which can reduce chances of hot spots forming and thus, reduce material failure and arcing. In FIG. 8, the carbon fiber yarn 102 is wound around the ceramic tube 100 twice (once from left to right and then once from right to left) such that the yarn 102 overlaps itself. As the number of passes increases, more pathways for the current to move is provided, which can reduce resistance. In some embodiments, the number of layers of carbon fiber yarn 102 wound around the ceramic tube is between 1 and 20 or about 2 and 10, for example. In addition to the amount of coverage that the carbon fiber yarn 102 provides over the ceramic tube 100, the winding shape also can influence the resistance and thus, performance of the heating element. For example, the winding shape in FIGS. 7-9 may be referred to as “hoops” while the winding shape in FIG. 10 is referred to as an “X.” While FIGS. 7-10 show the carbon fiber yarn 102 wrapped around the ceramic tube 100 circumferentially, it will be appreciated that the carbon fiber yarn 102 may be wrapped around the ceramic tube 100 axially. In some such axial wrapping embodiments, the frit-coated carbon fiber yarn 102 is still arranged completely on the outside of the ceramic tube 100 such that a fluid traveling through the ceramic tube 100 does not contact the frit-coated carbon fiber yarn 102.

Although certain embodiments have been shown and described, it is understood that equivalents and modifications falling within the scope of the appended claims will occur to others who are skilled in the art upon the reading and understanding of this specification.

What is claimed is:

1. A heating element comprising:
a ceramic tube having a central portion arranged between a first end portion and a second end portion;
carbon fiber yarn wrapped around the ceramic tube from the first end portion to the second end portion;
a frit coating arranged at least on the carbon fiber yarn wrapped around the central portion of the ceramic tube;
a first conductive component coupled to the carbon fiber yarn at the first end portion of the ceramic tube; and
a second conductive component coupled to the carbon fiber yarn at the second end portion of the ceramic tube.

2. The heating element of claim 1, wherein the carbon fiber yarn surrounding the first end portion and the second end portion is substantially free from the frit coating.

3. The heating element of claim 1, wherein the frit coating is arranged on the carbon fiber yarn wrapped around the first and second end portions of the ceramic tube.

4. The heating element of claim 1, wherein the central portion of the ceramic tube is bead blasted.

5. The heating element of claim 1, wherein the central portion of the ceramic tube has a different surface roughness than the first and second end portions of the ceramic tube.

6. The heating element of claim 1, wherein the first conductive component and the second conductive component include a first conductive layer arranged on the first end portion and the second end portion of the ceramic tube, and wherein the first conductive layer is arranged directly between the carbon fiber yarn and the ceramic tube at the first and second end portions.

7. The heating element of claim 6, wherein the first conductive component and the second conductive component each further comprise a second conductive layer arranged on the carbon fiber yarn at the first end portion and the second end portion of the ceramic tube.

8. The heating element of claim 7, wherein the second conductive layer is arranged on outer surfaces and end surfaces of the carbon fiber yarn at the first and second end portions of the ceramic tube.

9. The heating element of claim 1, wherein the first and second conductive components further comprise a conductive clamp wrapped around and configured to secure the carbon fiber yarn to the ceramic tube.

10. The heating element of claim 1, wherein the first and second conductive components comprise wire wrapped around the carbon fiber yarn.

11. The heating element of claim 10, wherein the wire is silver plated copper, and wherein the wire is in a braided structure.

12. A heating element comprising:
a ceramic tube having a central portion arranged between a first end portion and a second end portion;
carbon fiber yarn wrapped around the ceramic tube from the first end portion to the second end portion;
a frit coating on the carbon fiber yarn wrapped around the ceramic tube, wherein the carbon fiber yarn surrounding the central portion of the ceramic tube contains more of the frit coating than the carbon fiber yarn surrounding the first and second end portions of the ceramic tube;
a first conductive component coupled to the carbon fiber yarn at the first end portion of the ceramic tube; and
a second conductive component coupled to the carbon fiber yarn at the second end portion of the ceramic tube.

13. The heating element of claim 12, wherein up to 10% of the carbon fiber yarn surrounding the first and second end portions of the ceramic tube is coated with the frit coating.

14. The heating element of claim 12, the first conductive component and the second conductive component each comprising a bottom conductive layer arranged between the respective end portion of the ceramic tube and the carbon fiber yarn, and a top conductive layer arranged on outer surfaces and end surfaces of the carbon fiber yarn arranged on the respective end portion of the ceramic tube.

15. The heating element of claim 14, further comprising an insulating shield arranged over the carbon fiber yarn at least one the central portion of the ceramic tube, the insulating shield being thermally insulative and electrically conductive.

16. A method of forming a heating element comprising:
obtaining a ceramic tube comprising a central portion between end portions;
applying a first layer of a conductive material to each end portion of the ceramic tube;
obtaining a carbon fiber yarn;
coating the carbon fiber yarn in a frit composition;
winding the frit-coated carbon fiber yarn around the ceramic tube; and
heating the ceramic tube to cure the frit composition.

17. The method of claim 16, further comprising performing a texturing process on the central portion of the ceramic tube to increase the surface roughness of the central portion compared to the end portions of the ceramic tube, wherein the texturing process is performed before winding the frit-coated carbon fiber yarn around the ceramic tube.

18. The method of claim 16, further comprising removing the frit composition from the carbon fiber yarn arranged on the end portions of the ceramic tube.

19. The method of claim 16, further comprising applying a second layer of the conductive material over the carbon fiber yarn at the end portions.

20. The method of claim 19, further comprising coupling an electrically conductive component at least one of the first or second layers of the conductive material.
